(19) United States
(12) Patent Application Publication
(10) Pub. No.: US 2007/0251636 A1
(43) Pub. Date: Nov. 1, 2007

(54) Bonding elastic to fabric of a garment

(76) Inventor: Anthony Herbert, Kowloon (HK)

Correspondence Address: NOTARO AND MICHALOS, 100 DUTCH HILL ROAD, SUITE 110, ORANGEBURG, NY, 10962-2100, US

(21) Appl. No.: 11/416,366

(22) Filed: May 1, 2006

(51) Int. Cl. B29C 53/00

(52) U.S. Cl. 156/217; 156/443; 428/121

(57) ABSTRACT

A seamless elastic trim having improved elasticity and elastic recovery is disclosed. The trim preferably comprises a cut edge, an elastic band, and a peripheral section of a fabric material folded over upon itself to form a substantially flat hollow structure for enclosing the elastic band. An adhesive layer is disposed on one side of the elastic band, and the elastic band is attached to a surface of the hollow structure by thermal or ultrasonic bonding, or by any suitable bonding material or technique. The elastic band may be provided continuously, or at predetermined intervals within the hollow structure. Likewise, the adhesive layer may cover the entire length of the elastic band, or the coverage may be confined to fixed intervals. A method and apparatus for fabricating the seamless elastic trim of the present invention along the periphery of a material are also disclosed.

### FIELD AND BACKGROUND OF THE INVENTION

Throughout this application, various references are cited to describe the state and content of the art. Those disclosures, in their entireties, are hereby incorporated into this application by reference.

The present invention relates generally to a seamless elastic trim or finished edges of a garment having improved elasticity and elastic recovery.

The present invention also relates to a method of making such seamless elastic trim or finished edges along the periphery of a garment.

Seamless trims have been provided on garments, such as bras, underwear, swimwear, camisole, diapers, and articles of clothing worn directly next to the skin, to enhance the user's comfort while wearing the garment. Seamless trims provide the garment with an aesthetically pleasing look while preventing the garment from fraying at the periphery. Frequently, it is desirable to have the trim conform with the contours of the body, such as for providing greater support or better anatomical fit. This is achieved by forming the trim with an elastic insert.

Formation of elastic seamless trims is typically accomplished by providing an adhesive layer on both sides of the elastic insert, enclosing the elastic insert within the trim, and melding the adhesive layers with the elastic insert and trim by thermal or ultrasonic welding. See, e.g., Cano, U.S. Patent Application Publication No. US 2004/0238103. The resulting trim has solidified adhesives permeated through the elastic insert and garment, thereby reducing the elasticity and elastic recovery of the elastic insert, and giving the trim a stiffer feel. Elastic seamless trims are also produced by ultrasonically bonding the fabric to itself to create a tunnel along the fabric edge. The elastic band is, then inserted through the tunnel, but without attaching the elastic band to the walls of the tunnel. See, e.g., U.S. Pat. No. 6,622,312 to Rabinowicz. The drawback of this type of trim is that a cylindrical bulge along the edge of the trim may appear through the wearer's outer clothing. Alternatively, elastic seamless trims are produced by fusing thermoplastic materials in the elastic insert and fabric. See, e.g., U.S. Application Publication No. US 2004/0106354 to Falla, et al. This method produces regions or pockets of hardened thermoplastic material which reduces the comfort level for the wearer.

Accordingly, a need remains for an elastic seamless trim that is capable of overcoming one or more of the above-mentioned disadvantages. It is contemplated that the formation of the elastic seamless trim of the present invention by thermal or ultrasonic welding does not reduce the level of comfort for the wearer or impact the elasticity and elastic recovery of the fabric or elastic insert.

The following references are cited to show the state of the art: U.S. Pat. Nos. 4,382,303 to Lunt, 6,622,312 to Rabinowicz, and 5,820,443 to Burr, and U.S. Patent Application Publication Nos. US 2002/0079039 to Azulay, US 2004/0106354 to Falla, et al., US 2004/0224604 to Luk, US 2002/0111119 to Johnson, et al., US 2004/0238103 to Cano, and US 2005/0274460 to Cartabbia; the last cited reference showing an example of a machine that can be used to create the trim of the present invention.

### SUMMARY OF THE INVENTION

It is an object of the present invention to provide the periphery or trim of a material, such as a fabric or bra in particular or a garment in general, with a smooth, finished edge and having a thin profile. When the finished edge is provided, for example, on the periphery of an item of underwear, i.e., a brassiere, it is fabricated such that the soft, satiny feel of the fabric and the flexibility and elastic recovery of the elastic band enclosed within the finished edge or trim is not affected. The finished edge preferably comprises a cut edge, an elastic band or cord, and a section of the material folded over upon itself and hemmed to form the finished edge. The folded section of the material defines a flat hollow structure for enclosing the elastic band or cord. On one side of the elastic band or cord, there is provided an adhesive layer for bonding the elastic band or cord with the interior wall of the hollow structure by ultrasonic or thermal welding, or by a suitable bonding technique.

It is another object of the present invention to provide a method of fabricating the finished edge as described above along the periphery of a material. The method preferably comprises providing an elastic band or cord along the periphery of the material, aligning the elastic band or cord generally parallel with the edge of the material, disposing a heat activatable or curable adhesive layer on one side of the elastic band or cord, folding the periphery of the material to form a flat hollow structure for enclosing the elastic band or cord, attaching the elastic band or cord to the interior of the hollow structure, and hemming the opening of the hollow structure to form the finished edge. It is understood that the attaching and hemming operation can be carried out sequentially or simultaneously. It is also understood that hemming can be effected by ultrasonic or thermal welding, or by a suitable bonding technique.

It is a further object of the present invention to provide an apparatus for fabricating the finished edge as described above along the periphery of a material. The apparatus preferably comprises a dispenser configured to store and dispense an elongated elastic band or cord, which has an adhesive layer disposed continuously or intermittently on one side of the elastic band or cord; a work surface configured to guide and support the material being provided with the finished edge; an aligning element configured to hold the elastic band or cord over the material at the appropriate position and orientation; a folding element configured to fold the periphery of the material along a fold axis to form a hollow structure for enclosing the elastic band or cord; and a joining element configured to attach the elastic band to the hollow structure and to hem the opening of the hollow structure. It is understood that the adhesive layer can be deposited on the interior surface of the hollow structure instead of on the elastic band or cord. It is also understood that the apparatus of the present invention can include a dispenser for disposing an adhesive layer on the elastic band or cord continuously, or at appropriate intervals, along a longitudinal axis of the elastic band or cord.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a composite view that shows the periphery of a breast support garment fabricated with the finished edge or trim of the present invention.

FIG. 2 is a sectional view of the periphery of a material with an adhesive layer and an elastic band.

FIG. 3 shows the periphery of the material folded over upon itself.

FIG. 4A shows the periphery of a material formed with finished edge or trim of the present invention.

FIG. 4B shows a finished edge or trim of the present invention formed with longitudinal strips of adhesive disposed on one side of the elastic band.

FIG. 4C shows strips of adhesive disposed traversely with respect to the finished edge.

FIG. 5 is a sectional view of the periphery of a material with an adhesive layer and an elastic band according to a tunneling embodiment of the invention.

FIG. 6 is a view similar to FIG. 5 of the closed tunnel of the invention.

### DESCRIPTION OF THE PREFERRED EMBODIMENTS

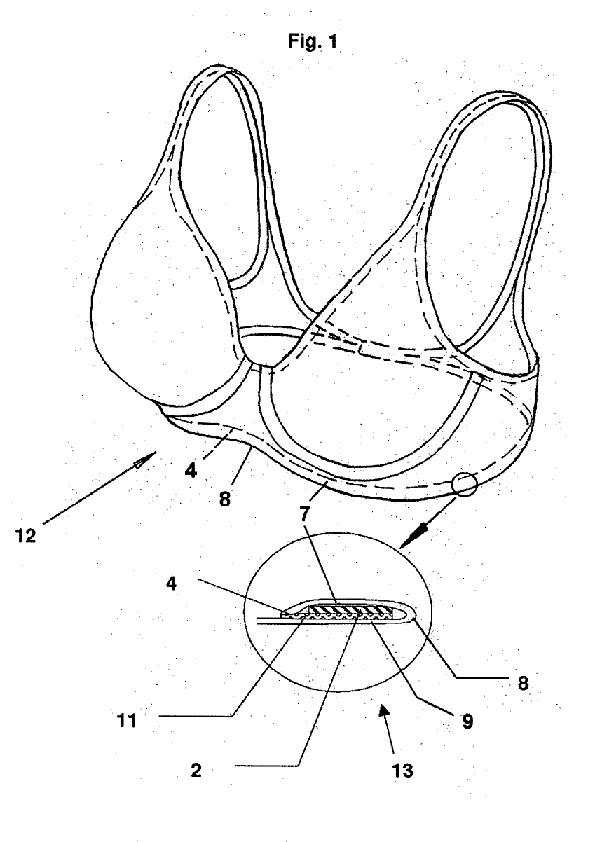

Referring now to the drawings, in which like reference numerals are used to refer to the same or similar elements, FIG. 1 shows a close-up view 13 of the periphery of a breast support garment 12, such as a bra, fabricated with the finished edge or trim of the present invention. As shown in FIG. 2, there is illustrated the periphery of a material 3, such as a fabric for an underwear, brassiere, or other article of clothing, having a cut edge 4. The fabric can be a non-woven, woven, or knitted fabric. The fabric can be made from silk, nylon, wool, polyester, cotton, linen, spandex or rayon fibers, or from yarns of a blend of at least two or more of such fibers. Fabric made from natural, synthetic, or thermoplastic fibers, or a suitable blend of such fibers can also be fabricated with the finished edge or trim of the present invention. Other yarns or blends known or to be discovered for bras or other undergarments, as would be used by those skilled in the art of manufacturing such garments, may also be used.

An elastic member 2, such as an elastic band or cord, having an adhesive layer 1 is disposed continuously, or at appropriate intervals, along the periphery of the material. The elastic band may be made of lycra, spandex, rubber, latex, synthetic elastomers, or other known or to be discovered material that is suitable, or a material comprising two or more of such fibers.

The adhesive layer, e.g., formed of adhesives activatable by heat, radiant or ultrasonic energy or of hot melt adhesives, is preferably disposed on one side of the elastic member, and runs continuously, or at appropriate intervals, along the length of the elastic member. Examples of heat-cured adhesives include curable hot melt adhesives and urethane. Such adhesives are commercially available, e.g., from Bostik-Findley, Adhesive Films, Adhesives Research Inc and Bemis. In one embodiment, the adhesive layer is disposed at uniform intervals along the elastic member, and covers about 10-20% of the elastic member. In a separate embodiment, the adhesive layer covers about 50% of the elastic member. Other adhesives suitable for thermal, ultrasonic, or pressure bonding of the elastic member and fabric without affecting their elasticity and mechanical properties may be employed.

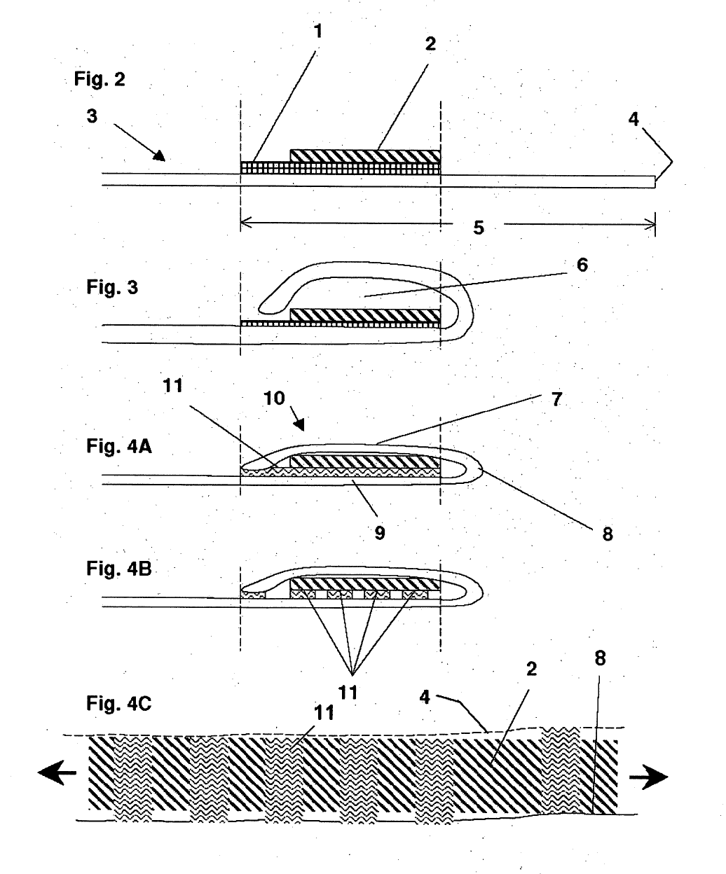

FIG. 3 shows a section 5 of the periphery folded over upon itself to form a flat hollow structure 6. FIG. 4A shows an edge trim 10 of the present invention comprising a hollow structure defined by a first part 7, a second part 9, and a finished edge 8. The elastic member 2 and the cut edge 4 are attached to the second part 9 by thermal or ultrasonic welding, or by a suitable adhesive and or bonding technique. Alternatively, the adhesive layer 1 can be provided on an interior wall of the hollow structure 6. It is noted that the finished edge has a generally semicircular or convex configuration. It is also noted that the thermal or ultrasonic bonding operation of the elastic member 2 and cut edge 4 can be performed sequentially or simultaneously. FIG. 4B shows an adhesive layer which has been activated by heat, radiant or ultrasonic energy (i.e., activated adhesive layer 11) and partially disposed on one side of the elastic member 2.

FIGS. 2 through 4 illustrate in sequence a method of providing the finished edge or trim of the present invention along the periphery of a material. The method comprises providing an elastic member 2 parallel to the edge of the material 3; disposing a heat activatable or curable adhesive layer 1 on one side of the elastic member 2; folding the section 5 along a fold axis to enclose the elastic member 2 and to form the first 7 and second 9 part and the finished edge 8; joining the elastic member 2 to the first 7 or second 9 part; and joining the cut edge 4 to the second part 9. The joining operations can be carried out using techniques and materials readily known in the art, such as heat-curable adhesive, thermal welding, ultrasonic welding, pressure welding, etc. In an embodiment, the joining operations are performed simultaneously or sequentially. In another embodiment, the adhesive layer is disposed on the first 7 or second 9 part. It is understood that the adhesive layer can be pre-applied to the elastic member.

The present invention also provides an apparatus for fabricating the finished edge or trim as shown, e.g., in FIGS. 1 and 4, along the periphery of a material. The apparatus comprises a dispenser for storing and dispensing an elongated elastic band having an adhesive layer disposed continuously, or at appropriate intervals, along one side of the elastic band; a work surface configured to guide and support the material; an aligning element configured to position the elastic band over the material; a folding element configured to fold the material along an axis parallel to the edge of the material, as the elastic band and material are moved across the working surface during the fabrication process; a joining element configured to attach the elastic band to the interior of the folded section and to hem the opening of the folded section. In one embodiment, the joining element is a thermal or ultrasonic welding unit. The various operational elements of the apparatus are arranged and configured to provide the finished edge or trim of the present invention, preferably continuously, along the periphery of a material, and can be operated by a controller to automate the apparatus. The controller preferably comprises a memory, a firmware, a program, a data storage unit, and a processor connected to a signal interface. The signal interface is adapted to transmit control signals to and to receive or process feedback signals from the operational elements of the apparatus.

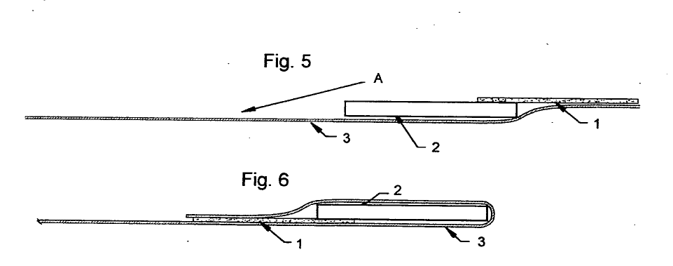

Referring now to FIGS. 5 and 6, in which like reference numerals are used to refer to the same or similar elements as in FIGS. 1-3, FIG. 5 illustrates another embodiment of the invention in an open condition for the edge area material 3 of the garment, such as a bra, of any suitable fabric such as non-woven, woven, or knitted fabric of silk, nylon, wool, polyester, cotton, linen, spandex or rayon fibers, or from yarns of a blend of at least two or more of such fibers. An elastic member 2, such as an elastic band or cord, having an adhesive layer 1 is disposed to partly overlay the fabric and elastic member as shown. The elastic band may be made of lycra, spandex, rubber, latex, synthetic elastomers, or other known or to be discovered material that is suitable, or a material comprising two or more of such fibers.

The adhesive layer, e.g., formed of adhesives activatable by heat, radiant or ultrasonic energy or of hot melt adhesives, is disposed partly and on one side of the elastic member. The edge area is then folded over n the direction of arrow A to the condition of FIG. 6 where the adhesive layer 1 is activated, e.g., by pressure and heat, to seal the elastic member 2 inside a tunnel of fabric material 3.

While specific embodiments of the invention have been shown and described in detail to illustrate the application of the principles of the invention, it will be understood that the invention may be embodied otherwise without departing from such principles.

What is claimed is:

1. An edge trim of a material having improved flexibility and elastic recovery, comprising:
a cut edge;
an elastic member along the cut edge;
a section of said material folded over upon itself to form a first and second part and a finished edge;
said first and second part and said finished edge define a substantially flat hollow structure and arranged to enclose said elastic member;
said first part having said cut edge on one end;
said first part being attached to said second part at about the cut edge, and only one side of said elastic member being attached to an inner surface of said hollow structure, by one of: ultrasonic bonding, thermal bonding, and a bonding material;
said elastic member extending substantially parallel and along said finished edge.

2. The edge trim of claim 1, wherein said material is a fabric adapted for making garment.

3. The edge trim of claim 2, wherein said fabric is a non-woven, woven, or knitted fabric.

4. The edge trim of claim 2, wherein said fabric is made from natural, synthetic, or thermoplastic fibers, or a combination thereof.

5. The edge trim of claim 2, wherein said fabric is made from silk, nylon, wool, polyester, cotton, linen, or rayon fibers, or a combination of two or more of said fibers.

6. The edge trim of claim 2, wherein said garment is one of: an underwear, a bra, a camisole, a swimsuit, a diaper, and a garment to be worn against the skin.

7. The edge trim of claim 1, wherein said elastic member extends continuously, or intermittently in an uniform manner, along said hollow structure.

8. The edge trim of claim 1, wherein said elastic member is attached to said hollow structure by a method comprising the steps of:
providing an adhesive between one surface of said elastic member and one surface of said hollow structure; and
simultaneously mating said hollow structure and elastic member, and activating said adhesive.

9. The edge trim of claim 8, wherein the adhesive is a heat activated adhesive, or a curable hot melt adhesive.

10. The edge trim of claim 1, wherein a heat activable or curable adhesive layer is disposed on one side only of said elastic member or on one surface only of said hollow structure.

11. The edge trim of claim 10, wherein said adhesive layer is disposed continuously, or at regular intervals, along said side or surface.

12. The edge trim of claim 11, wherein said adhesive layer is disposed at uniform intervals along said side or surface, and covers about 10-20% of said side or surface.

13. The edge trim of claim 11, wherein said adhesive layer is disposed at uniform intervals along said side or surface, and covers about 50% of said side or surface.

14. The edge trim of claim 10, wherein the adhesive layer is activated by heat, radiant or ultrasonic energy, or a by a combination thereof to form a secure bond between said elastic member and tubular structure.

15. The edge trim of claim 8, wherein the adhesive is activated by heat, radiant or ultrasonic energy, or a by a combination thereof to form a secure bond between said elastic member and tubular structure.

16. The edge trim of claim 10, wherein said adhesive layer is activated or cured by heat or pressure, or by a combination thereof.

17. The edge trim of claim 8, wherein the activated adhesive layer or the bonding operation does not alter the elasticity and or resiliency of said material or elastic member.

18. A method for fabricating the edge trim of claim 1 along the periphery of a material, comprising:
providing said elastic member generally parallel to the periphery of said material;
providing a heat activatable or curable adhesive layer on only one side of said elastic member or on only one inner surface of said first or second part;
folding said section upon itself to form said first and second part and said finished edge;
arranging said elastic member between said first and second part;
joining said elastic member to the inner surface of said hollow structure; and
attaching said cut edge of said first part to said second part.

19. The method of claim 18, wherein the joining and attaching step is performed concurrently or sequentially.

20. A method of claim 18, wherein the width of said first and second part is at least the width of said elastic member.

21. An apparatus for fabricating the edge trim of claim 1 along the periphery of
a material, comprising:
a dispenser for storing and dispensing an elongated elastic band having an adhesive layer disposed continuously, or at uniformly spaced intervals, along only one side of said elastic band;
a work surface configured to guide and support said section;
an aligning element configured to maintain said elastic band over said section at an appropriate position and orientation;
said elastic band being positioned by said aligning element over the area of the section forming said second part, and oriented in parallel with said second part;
a folding element configured to fold said section upon itself along a line extending between said first and second part, as said material and elastic band is moved across said work surface; and
a joining element configured to simultaneously attach said elastic band with said first or second part, and to attach said first apart about said cut edge to said second part,
wherein said operational elements are arranged and configured to provide the periphery of said material with said edge trim in a continuous manner, or at predetermined intervals.

22. The apparatus of claim 21, wherein said joining element comprises a thermal or ultrasonic welding unit.

23. The apparatus of claim 21, further comprising a controller adapted to automate said apparatus,
wherein said controller comprises a memory, a firmware, a program, a data storage unit, and a processor connected to a signal interface,
wherein said signal interface is adapted to transmit control signals to and to receive or process feedback signals from said operational elements of said apparatus.
